(19) United States
(12) Patent Application Publication
(10) Pub. No.: US 2014/0251882 A1
(43) Pub. Date: Sep. 11, 2014

(54) SEGMENTED BIOFILTRATION STACKS

(71) Applicant: E. Craig JOWETT, Rockwood (CA)

(72) Inventor: E. Craig JOWETT, Rockwood (CA)

(21) Appl. No.: 13/794,488

(22) Filed: Mar. 11, 2013

(51) Int. Cl. C02F 3/10

(52) U.S. Cl. CPC C02F 3/10
USPC 210/151; 210/150

(57) ABSTRACT

A segmented, stackable wastewater treatment apparatus suitable for small remote and temporary camps is provided. The segments are typically flat cylindrical in shape and contain permanent biofiltration medium such as absorbent foam. They are transported to site in small vehicles or aircraft and assembled into a stack to treat the sewage. After use, they are disassembled into the component segments, which are then transported by small vehicles or aircraft to the next site, re-assembled in a stack, and re-used.

This technology relates to wastewater treatment primarily in remote and temporary outposts and camps.

### LIST OF PRIOR PATENT PUBLICATIONS

U.S. Pat. No. 5,618,414 (Goupil+, 1997) Treatment system for treating waste water.
U.S. Pat. No. 5,707,513 (Jowett+McMaster, 1997) Wastewater treatment method and apparatus.
U.S. Pat. No. 6,393,775 (Staschik, 2002) Utilities container.
U.S. Pat. No. 6,749,745 (Jowett, 2004) In-pipe wastewater treatment system.
U.S. Pat. No. 6,977,038 (Jowett, 2005) Wastewater treatment station in shipping-container.
U.S. Pat. No. 7,097,768 (Talbot+, 2006) Coconut mesocarp-based biofilter material and its use in a wastewater treatment system.
U.S. Pat. No. 7,459,077 (Staschik, 2008) Portable apparatus for in-transport treatment of waste.
US-2011/0284438 (Jowett+James, 2012) Three-dimensional filament matrix as biological filtration medium.

This technology provides an apparatus for biofiltration of wastewater using self-contained filtration modules or segments suitable for remote and temporary camps. The segments can be stacked up on each other in a repetitive sequence to treat a variety of flows. They are dis-assembled for ease of transportation by light equipment, vehicles or aircraft, and are re-used in their original form after being re-assembled into segmented stacks.

For treatment of wastewater in permanent camps, e.g., in mining installations or oil production facilities, treatment plants are brought to site or assembled on site and installed, often buried, and used for many years. These can be for large or small camps because the longer time period for construction allows relative easy movement by ice road, summer barge, even large aircraft, and there is typically large equipment on site to handle the heavy units.

For large permanent camps, high-energy mechanical sewage treatment methods can be employed, as there are permanent maintenance staff present and adequate power generation. However, for smaller temporary camps, e.g., in the mining and oil & gas exploration sector or in the construction industry, low-energy and low-maintenance filtration systems are preferred because of their ease of use and ease of remobilization. Regulations requiring environmental recovery of the site to pre-camp condition are becoming more stringent, and clean up of infrastructure can be a necessity.

For temporary camps, pre-assembled, transportable filtration units are available as shipping containers (e.g Staschik 2002; Jowett 2005), covered trailers (e.g Staschik 2008), or as a number of specially made tanks on permanent pallet bases. When the camp is abandoned, these units are disconnected and can be moved to a new camp by truck or other heavy equipment and re-connected for continued use. In certain configurations (e.g Staschik 2008), sewage treatment continues during transportation between camps.

These transportable units are suitable for larger camps of 100-200 person size or more, but are not suitable in most cases for camps of a few to fifty person size, nor are they suitable for remote-access camps. Due to their large weight and size, they involve proper roads and heavy equipment or vehicles to move them between sites, and are not suitable for use in camps with access by boat, small vehicle, helicopter or small aircraft.

In exploration ‘fly-in’ camps with twenty to fifty people, a filtration system is ideal for passive, low-energy sewage treatment, but the filtration unit to treat the whole camp are too heavy to be removed by helicopter sling or small floatplane, especially after use when it is wet and heavy. A system is desired whereby the filtration unit can be assembled from smaller components, and dis-assembled after use for slinging under a helicopter, and then re-assembled from its component parts at the new camp.

There are suitable low-energy filtration systems for smaller camps that have re-useable fibreglass housings, with peat filtration medium in easily transportable bags as described in Goupil 1997, or with coir filtration medium as described in Talbot 2006. Although the housings can be transported between camps and re-used, the peat or coir filter medium is wet, very heavy and typically not re-useable. Often, it is shovelled out by hand and dried out for weeks or months before being taken off the site, involving additional visits to the remote sites, and creating a disposal issue. New medium is brought in to the new camp and carefully re-installed in the housings, involving extra labour and additional expense.

Other systems in lightweight HDPE tanks, for instance, with lightweight foam filtration medium as described in Jowett+1997 are suitable for treating wastewater at remote sites, being transportable by small craft or vehicle. After use their weight increases from 300-400 kg to 1000-2000 kg, depending on duration and type of use, and the foam medium has to be removed by hand from the tanks and bagged when sufficiently heavy equipment is not available. The empty tanks can be transported easily and the used bagged filter medium can be re-installed easily at the next site, but does involve extra labour or expense.

To treat larger camps, these filtration units can be used in multiple units arranged separately, but this decentralized configuration involves more plumbing between the units, rotating dispersal of the medium, more land area, and has a greater chance of pipe failure and freezing.

There is a need for a transportable, low-energy filtration treatment module that can be moved by boat, small vehicle, or small aircraft to remote camps for temporary use. The modules should be designed to be assembled into a single, larger unit for treating larger flows, and be able to be dis-assembled after use into their component parts for easy transport by small aircraft or vehicle, without having to remove the filtration medium.

The filtration apparatus should combine the properties and characteristics of:

(i) a low-energy, biological filtration system, with:
(a) light-weight filtration medium,
(b) re-useable medium,
(c) medium kept in and transported in original containers, and
(ii) transportable filtration containers as individual filtration segments, being:
(a) self-contained for transportation as individual segments,
(b) assemblable in a stack to treat larger flows,
(c) dis-assemblable for transportation with used filtration medium,
(d) of non-corrosive material,
(e) rugged for multiple rough for multiple transports and assemblies, and
(f) preferably of a flat cylindrical shape to roll by hand.

In the present technology, a new means of providing low-energy filtration treatment at temporary and remote camps is described. The apparatus consists of two types of filtration segments, i.e top & bottom segments and intermediate segments, stacked together to form larger or smaller systems. The segments are preferably made of fibreglass with insulated double walls and roofs for rugged structure and cold weather use. They are preferably shaped as flat cylinders (‘hockey-puck’ shape) to provide stable joining surfaces during operation, with suitable flanges or connection means to connect the stacked segments and remain structurally stable. The puck shape also allows the segments to be rolled by hand on the site, of benefit when equipment is in short supply. However, the segments can be manufactured in a non-rollable shape, where ability to roll is less important than e.g shaping the segments for dense packing in a limited space.

The top & bottom segments have one end open and one end closed. The closed end is made of fibreglass or other suitable container material fabricated and insulated similar to the walls, and these are used as either the roof cover or the floor base of the segment stack during operation of the system. Whereas the roof of the top segment could be made of any non-corrosive material, including fabric or plastic sheeting, it is preferable to include an insulated, rugged cover for cold climates and to withstand rough handling. The moulds for top and bottom segments can be made identical to save on manufacturing expense—only the plumbing is different and that is fabricated after the mould is made.

The open ends of the filtration segments are covered with a suitable rigid mesh made of PVC coated steel or similar and attached permanently to the sides of the segments. During transport, the mesh keeps the filtration medium within the segment, and during operation, it allows water and air to pass through to the next segment without resistance. The middle or intermediate segments have both ends open and covered with the rigid mesh to contain the filtration medium as described above.

The open flat ends with mesh cover act as the points of joining of the segments. These flat ends should be large enough so that they provide a stable base when stacked on each other. The sides of the segment flat ends have a joining mechanism such as a flange and bolt system, while more expensive to fabricate, is easy to assemble and dis-assemble with hand tools. Care should be taken to ensure that the bolt holes are spaced evenly or marked on the exterior to allow for ready assembly.

Another option is a nesting mechanism where one of the open flat ends has a continuous tab extension on its wall that is inserted into the adjacent open flat end. In this case it is important to prevent the two segments from being forced together to prevent dis-assembly, and suitable clearance should be allowed around the inserted tab.

The new technology comprises a manufactured apparatus wherein:

(i) filtration segments containing a biological filtration medium are stacked sequentially on top of each other;
(ii) the uppermost segment has a covered ceiling and a flat floor of rigid open mesh;
(iii) the lowermost segment has a covered floor and a flat ceiling of rigid open mesh;
(iv) segments to be stacked between the top and bottom segments have flat ceilings and floors of rigid open mesh;
(v) the segments are preferably circular in plan view and flat cylindrical in overall shape;
(vi) the segments are preferably double-walled and insulated for cold climate;
(vii) plumbing fixtures are preferably roughed in with:
(a) a gravity drain from the floor of the bottom segment,
(b) conduits for pipe connections through the intermediate segments, and
(c) a distribution or spray manifold in the top segment.

### LIST OF DRAWINGS

The new technology will now be further described with reference to the accompanying drawings, in which:

FIG. 1 is a diagrammatic cross-sectional side view of an assembled tower of segments, which is arranged to promote aeration of wastewater.

FIG. 2 is a close-up of two of the segments of the apparatus of FIG. 1.

FIG. 3 is a view corresponding to FIG. 2 of two segments from another apparatus.

FIG. 4 is a pictorial view of one of the segments of FIG. 3.

FIG. 5 is a cross-sectional side view of yet another assembled tower of segments, which is arranged to promote aeration of wastewater.

FIG. 6 is a view of some of the segments of FIG. 5, shown separated.

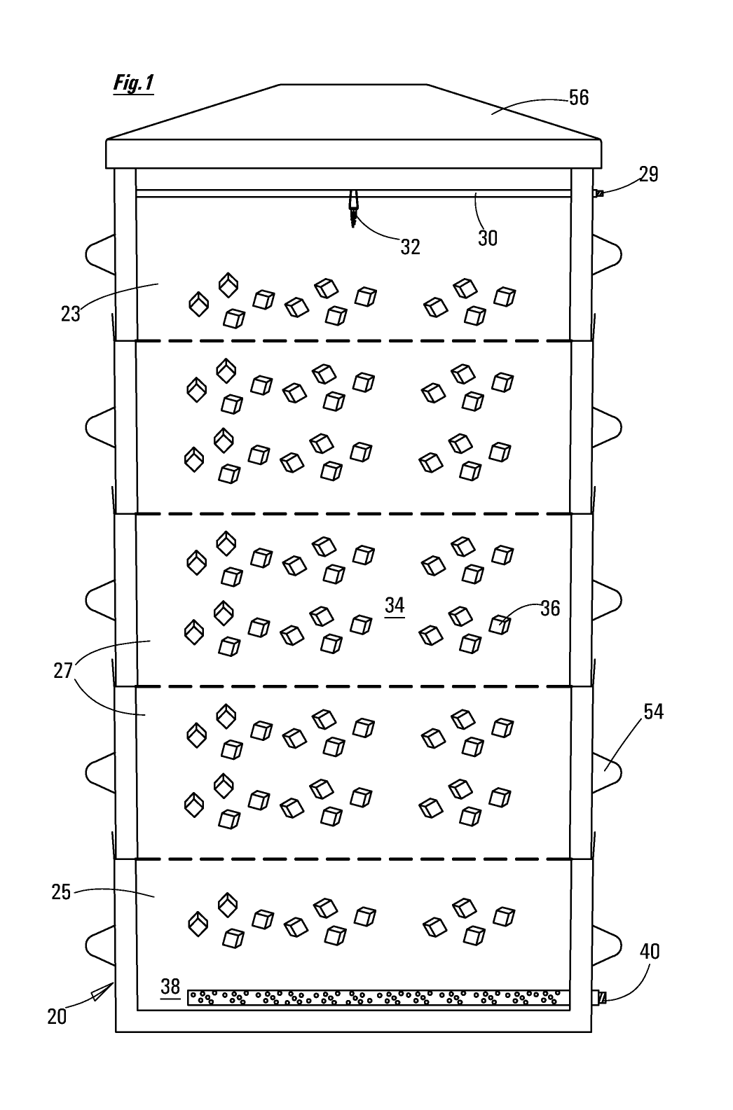

In FIG. 1, the segments of the stack 20 comprise a top segment 23, a bottom segment 25, and intermediate segments 27. The top segment 23 includes an inlet-port 29, into which wastewater (being e.g effluent from a septic tank) is pumped and piped. The wastewater enters a feed-pipe 30, to which a nozzle 32 is attached. The wastewater is pumped into the stack 20, preferably in intermittent doses at a high flowrate rather than in a slow steady stream.

The water sprays and sprinkles down onto segment-heaps 34 of blocks 36 of interconnected-cell plastic foam material. The material is sponge-like and resilient, being easily squeezable by a person, between the fingers. Typically, the blocks 36 are five-cm cubes. Another suitable size is 6½-cm cubes. It is important that the wastewater be distributed evenly over the up-facing area of the segment-heap of blocks, and the spray nozzle should be configured and positioned to ensure this.

Having passed downwards (under gravity) through the heaps of blocks of foam, the now-aerated water drips out of the bottom of the heaps into a collecting basin 38 of the bottom segment 25. The wastewater is conveyed out of the stack 20 through an outlet-port 40. The treated water might be disposed of, e.g into the ground, by way of a (conventional) soakaway—or might be collected (e.g in a holding tank) and taken away for further treatment and disposal.

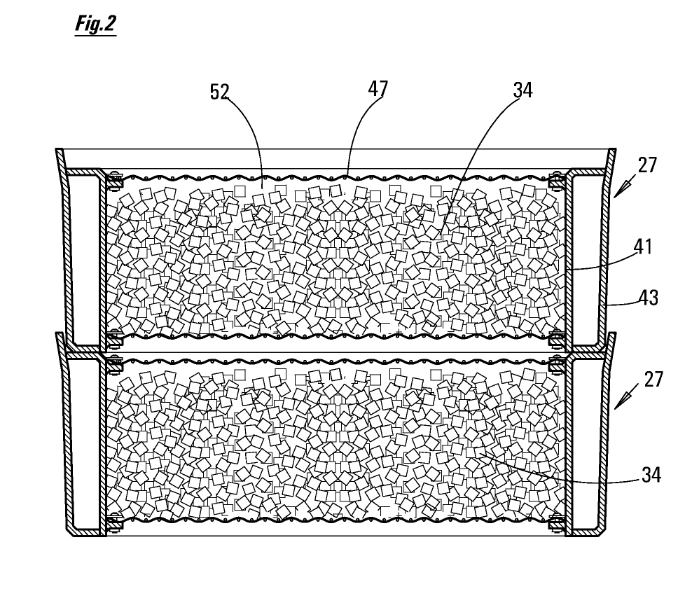

FIG. 2 is a sectioned side-view of two of the intermediate segments 27. The segment is fabricated from plastic sheet material. The inner of moulded plastic construction, and includes a moulded inner wall 41 and a moulded outer wall 43. The annular airspace between the two walls provides thermal insulation.

The circular opening at the top of the segment 27 is closed by a retainer 47 in the form of a sheet of plastic-covered-metal mesh. The bottom of the intermediate segment 27 also has a circular-opening which, likewise, is closed by a retainer 47 comprising a sheet of plastic-covered-metal mesh. Tabs are fixed (glued) to the inner wall 41, and the mesh retainers 47 are bolted to the tabs.

The mesh retainers 47 retain the cubes 36 of foam within the hollow interior cavity 52 that is created and defined by and between the inner wall 41 and the top and bottom retainers 47. Typically, the segment-cavity in the intermediate segment 27 is fifty cm high and 150 cm in diameter, and thus has a capacity of a little under one cubic metre. There is space for approximately five thousand five-cm cubes 36 (or three-thousand 6½-cm cubes) in such a segment-cavity 52.

The cubes 36 should not fill the segment-cavity 52. The cubes should not be packed together in neat rows. Rather, they should be piled into the cavity 52 in a random or haphazard manner. The blocks should rest on and against each other with the points of one cube touching the sides of the adjacent cubes, rather than the blocks touching each other side-to-side.

It is known that this random-heap arrangement of cubes serves to provide highly efficacious treatment of the wastewater, as will now be described.

The haphazard (not-ordered) arrangement of the segment-heap of cubes enables air to pass between and around the blocks. The arrangement also enables water to pass downwards from block to block; the hydrophilic nature of the foam material, and the sizes of the cells or pores, are arranged such that water does not trickle down the outside surfaces of the blocks, but rather the water passes bodily through the foam material of the blocks.

The interface between adjacent cubes can be characterized as a point contact. In fact, of course, the foam material of the blocks being resiliently flexible, the point of contact expands into an area, rather than a point, of contact. However, the contact area between one block and the block underneath is small, as measured against the capillary capacity of the foam block to hold and retain water. As a result, the water does not drain out of the blocks, between dosings. Rather, respective volumes of water are retained in the blocks.

In aggregate, a large volume of water is “held in the air”, inside the foam blocks, between dosings, and remains maximally exposed to the air for long periods due to the spaces between the foam blocks being open to the air.

During a dosing episode, the cubes at the top of the segment-heap of cubes become saturated. When dosing ends, the excess water drains out of the upper blocks, and enters the lower blocks. Thus, each dosing, the new water enters the topmost blocks; the water in those blocks drains into the blocks below; and the water in each individual block passes down into the block below, having been displaced by water from above—and so on down the heap, until each block once again contains only its own characteristic retained-volume.

Thus, the drops of water move in steps, cube to cube, down through the heaps. The water takes many hours, and many dosings, to travel from top to bottom of the segment-heaps, and the water undergoes aerobic exposure all the way.

The smaller the contact area a block makes with the block below, the greater the volume of water retained in that block. This retained-between-dosings volume of water is exposed to the air surrounding the block, and is exposed to the air. Colonies of aerobic microbes become established in the block, which act to break down the oxidizable fraction of organic matter in the water.

At the same time, a core at the centre of the retained volume is isolated from air-contact, and this core can be large enough that colonies of anaerobic or facultative microbes can become established in the anoxic core, which act to break down remaining matter in the water.

Although the foam cubes provide very thorough treatment of the water, other (cheaper) wastewater treatment-media materials can be used in place of the cubes. These other media-materials include other configurations of plastic foam material, and such other materials as peat, coconut, coir, etc. The media-material should be inert with respect to water (and to the contaminants contained in the water).

The other materials do not hold the water “up in the air” as much as the heaped cubes, and in fact, with some media materials (e.g a heap of pebbles), the water is only exposed to air during the actual dosing, and the water drains right out of the media, leaving the media substantially dry, between dosings. With the heaped cubes, the cubes retain a volume of water, i.e the water basically does not drain completely out of the cubes, even when the heap is no longer subjected to dosing.

The segment 27 preferably is hockey-puck-shaped, as shown, although other shapes are contemplated. Cylindrical is good, in that the segments can be rolled over the ground, for short-distance transportation.

When the segment 27 is manufactured, and is filled with (dry) cubes of plastic foam, typically it weighs ninety kilograms. At that, it is not impossible for the segment to be lifted and manhandled manually; however, in order to create the tower 20 of segments at the desired location, the services of a hoist are preferred, for lifting the segments into place, one on top of another. Eyelets 54 are provided on the outer walls 43 of the segments, for lifting purposes. The eyelets are collapsible, so as not to interfere with rolling the segments.

After a period of operational use, when the tower is to be dismantled, the blocks still contain a good deal of water, and the to-be-removed segment 27 typically weighs 150-200 kg, and the hoist should be rated accordingly.

It will be understood that, actually just at the end of a dosing episode, the segment might momentarily weigh considerably more—e.g 400 kg. However, it would not occur that the segments might have to be moved in that very heavy condition.

The top segment 23 is like the intermediate segment 27 in most respects. The top segment 23 is formed with the water-inlet-port 29, in which are fixed the feed-pipe 30 and to that, the nozzle 32. The presence of these components reduces the interior volume of the top segment that is available to be filled with media material.

The top segment 23 is provided with a loose lid 56, which drops over the top segment.

The bottom segment 25 is also like the intermediate segment 27 in most respects. The bottom segment 25 is closed at the bottom, thereby creating the collection-basin 38, for collecting the treated water that drips down out of the bottom of the heaps 34 of foam cubes. The bottom segment 25 can include a mesh retainer 47, which keeps the bottom heap of cubes out of the collection basin 38, or the cubes of the bottom heap can be allowed to rest in the collection basin. (If not retained in the segment-cavity, the cubes would fall out if and when the segment is rolled along the ground.) The outlet-port 40 conveys the collected water away.

The configuration of the assembled stack is such that the segments, together, contain and define a hollow interior vault of the tower. Facility should be provided, in the assembled stack, for movement of air through the segment-heaps of cubes. Thus, an air-entry port may be provided in the bottom segment, and a chimney in the top segment, to enable a through-flow of air in the up/down direction. The usual precautions should be taken to prevent precipitation, insects, etc, from entering the vault.

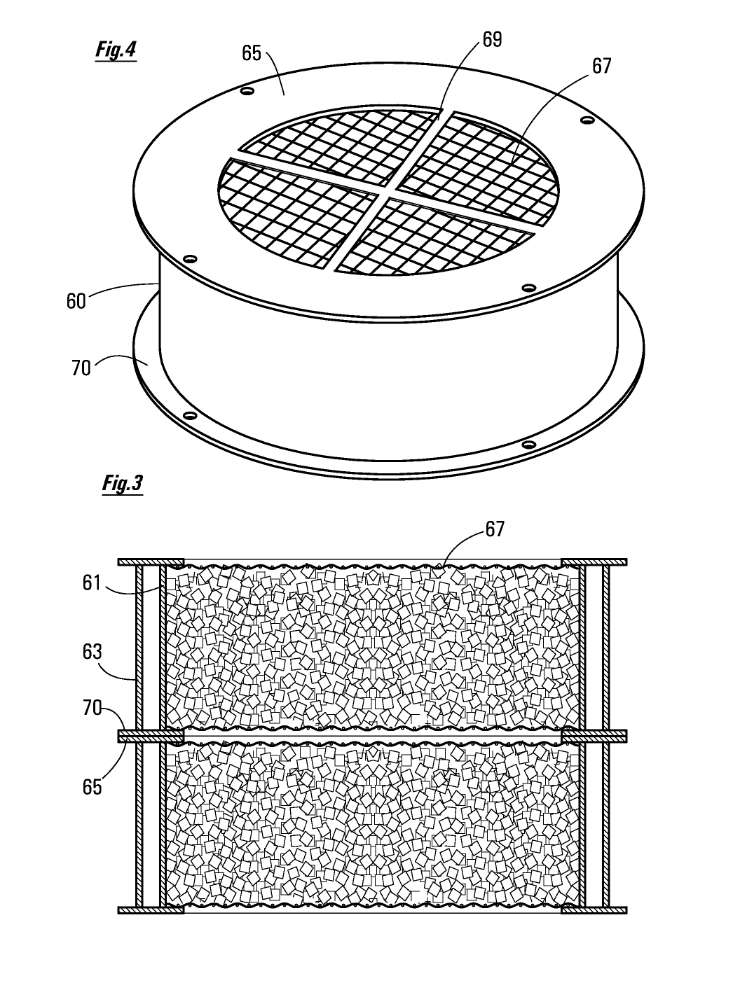

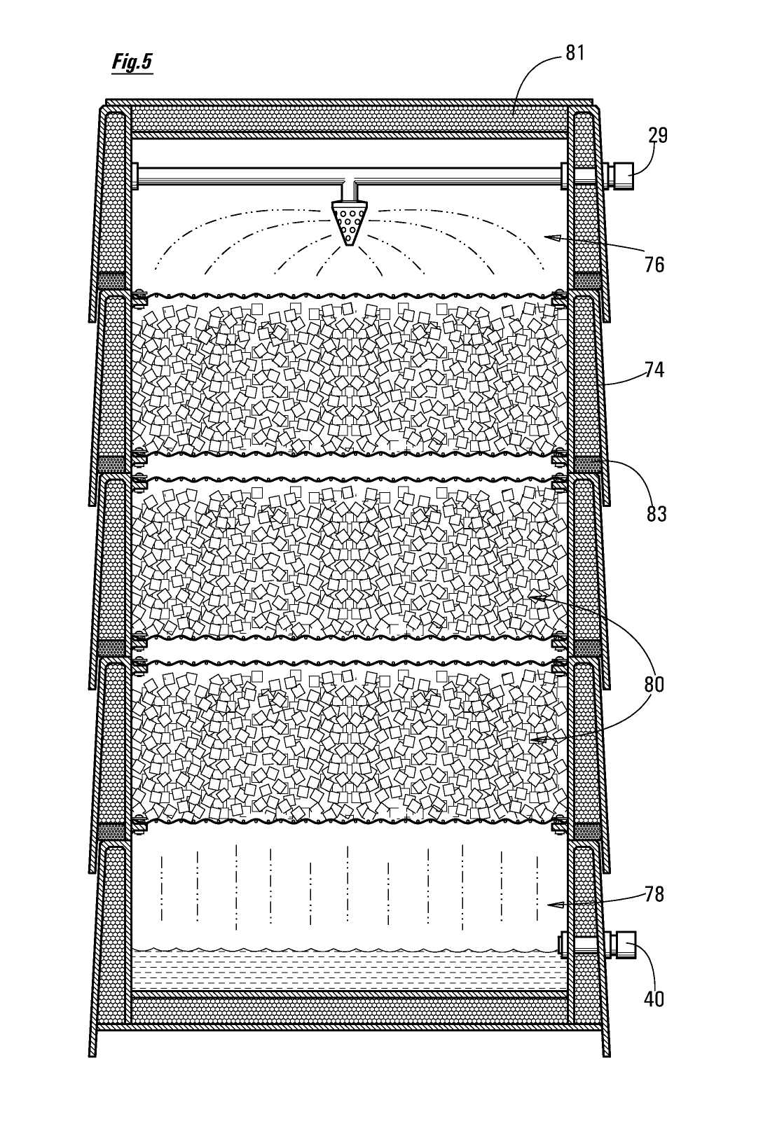

FIGS. 3,4 show a variant of the structure of the segments. FIG. 3 shows two of the intermediate segments 60, stacked one on the other. FIG. 4 is a pictorial view of one of the segments.

The segment 60 is fabricated from cylindrical inner and outer walls 61,63 of plastic, which are glued to upper and lower annular plastic flanges 65. As in FIG. 1, the circular opening inside the upper flange 65 is closed by a retainer 67 in the form of a sheet of plastic-covered-metal mesh. Crossbars 69 carried by the flange 65 provide support for fixing the mesh retainer 67. The mesh is secured to the crossbars with closed hooks, cable-ties, or the like.

The bottom of the intermediate segment likewise has an annular flange 70, of which the respective circular-opening is again closed by a retainer comprising a sheet of plastic-covered-metal mesh.

Gaskets or seals can be placed between the mating flanges 65,70 of adjacent segments, and the flanges should be bolted or clamped together. The wide annular flanges add great rigidity to the segments. The segments should be very robust, to cope with rough and abusive handling, and the flanges make a large contribution to that. (The mesh retainers contribute nothing to the desired robustness—and nor do the foam cubes.)

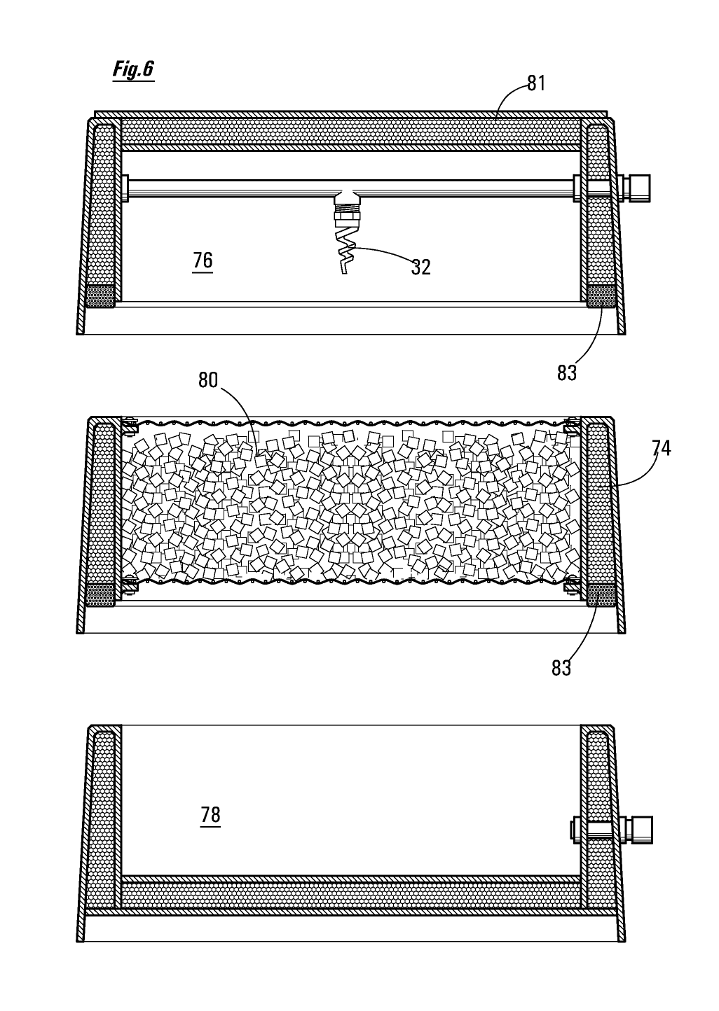

FIGS. 5,6 show another variant of the structure of the segments. Now, the double-wall-rings 74 are moulded in one piece. All the segments—i.e the top and bottom segments 76,78 and the intermediate segments 80—are formed over a common mould. The top segment 76 is closed at the top by a flat double-wall rigid-foam-cored sandwich slab 81 that is glued into the double-wall-ring 74 of the top segment. The bottom of the collecting basin of the bottom segment 78 is likewise formed from a flat double-wall rigid-foam-cored sandwich slab, which is glued into the moulded double-wall-ring. The moulded cavities in the double-wall-rings 74 are filled with rigid foam, which contributes to the rigidity and robustness of the segments.

The FIGS. 5,6 variant includes gasket-seals 83, which are of soft rubber or (non-interconnected-cell) foam. The gasket-seals are compressed when the segments are stacked on each other. The gasket-seals prevent water from leaking out of the joints between the segments, and also exclude air. As mentioned, the hollow interior cavity of the segments and the stack should be well-ventilated, preferably by providing air-holes in the top and bottom segments. It is preferred not to allow air to leak in between the stacked segments, since air circulation by that means would be uneven; the ventilation should be controlled by the designers.

In some cases, especially when the wastewater has a high ammonium content, it can be advantageous to provide a powered fan, to ensure good aeration and oxidation.

In FIG. 5, as shown the top and bottom segments 76,78 do not contain media material (e.g foam cubes). If the designers preferred those segments to contain media material, again foam-retainers (e.g of open mesh) should be provided, which allow air and water to pass into/through the segments substantially without any inhibition, but provide mechanical containment for the media material.

In FIGS. 3,4, the flanges 65 are plain, whereby the stack of segments is not securely stable unless the flanges are bolted or clamped together. By contrast, in FIGS. 1,2, and also in FIGS. 5,6, the segments are structured for nesting, whereby the segments form a secure and stable tower simply upon being placed one on top of another—when the segments are lying one on top of another, one of the segments forms a rim, which prevents the other segment moving relatively laterally.

It will be noted that an easy way to achieve the nesting configuration is to angle one (or both) of the inner and outer walls by the thickness of the wall—or rather, by a little more than that thickness, to provide clearance, so there is no tendency for the segments to become jammed together. In fact, when moulding the walls of the segment, it is advantageous to provide a draft angle, to facilitate releasing the moulding from the mould and it is simple for the designers to provide a draft angle that serves also to enable the nesting configuration and function.

Preferably, in FIGS. 5,6, the outer wall is moulded upon an annular segment-wall-mould, which is profiled in the form of the annular airspace. The profile of the mould includes a draft angle, so arranged that the moulded width of the airspace at the distal end of the profile is smaller than the moulded width of the space at the proximal end. The distal end and the proximal end of the segment-wall are provided with complementary nestling configurations. The difference between the two moulded-widths is such that, when the segments are assembled on top of one another to form the tower, the distal end of one segment and the proximal-end of the next-above segment nestle snugly and securely together, but with clearance.

It should be noted that the whole tower can be assembled, in the field, in a few minutes. The segments themselves can be sophisticated, in that the segments are manufactured in-factory—where the usual machine tools, skilled workers, quality inspectors, etc, are available. Specialists see to it that care is taken with manufacture and finishing, so the segments are robust enough to survive rough handling during transport and manhandling on-site under rough and even brutal conditions.

Assembly on-site is, by contrast, extremely simple. The segments are made ready for water-treatment operation simply by stacking the segments one on top of another (and bolting the flanges together, in FIGS. 3,4). Apart from connecting the inlet- and outlet-ports, there is no plumbing or connection of pipes and fittings to be done, and no connection of conduits. Water dripping down from one segment-heap of cubes passes straight into the segment-heap below. The desired movements of water and air through the apparatus are taken care of, by the simple act of mounting the segments one on top of another. The on-site assembly operation can be carried out in little time, even by casual and unskilled workers.

A problem can be encountered sometimes when the treatment apparatus includes a tall heap of foam blocks (such as that shown in FIG. 13 of U.S. Pat. No. 6,977,038, where the heap of cubes can be e.g two metres high). The problem is that, when the cubes contain water, the weight of the water-laden upper cubes of the heap bears down on the lower cubes, which can cause the lower cubes in the tall heap to be squashed more or less flat. In the present case, the fact that the media is divided between the segments, and each segment-heap of the media material is individually supported, means that, even though the tower as a whole might be over two metres tall, the individual segment-heaps, in the individual segments, are only e.g fifty cm in vertical height. Thus, all the cubes in the heap can be expected to remain intact and fully-operational, and the retained water in all the cubes is constantly well-exposed to aeration.

While intermediate supports could be provided in the traditional non-segmented biofilters, in the present technology the intermediate supports are provided for nothing, in that the retainers are already provided top and bottom of the segments, in order to contain the media material within the hollow interiors of the segments during transport and handling. The separation and support function, during operation, is a free bonus.

The foam media-material is, in itself, a good insulator, and rarely does it happen that the water within the apparatus freezes during normal operation, assuming several dosings per day. The double-wall structure of the apparatus 20 of FIGS. 1,2 provides further insulation of the open interior of the apparatus. If the apparatus should be left unused e.g for a few weeks, the water that remains captive in the cells or pores of the foam media material might eventually freeze. It may be noted that the bacteria that are responsible for breaking down the contaminants remain viable even when frozen—just as microbes in soil remain viable when the soil is frozen. They are merely dormant and will revive when dosing recommences—even if the temperature is still very low. Although not usually required, a heater may be provided in the apparatus, if desired, and if power is available.

Some of the physical features of the apparatuses depicted herein have been depicted in just one apparatus. That is to say, not all options have been depicted of all the variants. Skilled designers should understand the intent that depicted features can be included or substituted optionally in others of the depicted apparatuses, where that is possible.

Terms of orientation (e.g “up/down”, “left/right”, and the like) when used herein are intended to be construed as follows. The terms being applied to a device, that device is distinguished by the terms of orientation only if there is not one single orientation into which the device, or an image (including a mirror image) of the device, could be placed, in which the terms could be applied consistently.

Terms used herein, such as “cylindrical”, “vertical”, and the like, which define respective theoretical constructs, are intended to be construed according to the purposive construction.

The scope of the patent protection sought herein is defined by the accompanying claims. The apparatuses and procedures shown in the accompanying drawings and described herein are examples.

The numerals used in the drawings may be summarized as:
20 stack
21 treatment apparatus
23 top segment
25 bottom segment
27 intermediate segment
29 inlet-port
30 feed-pipe
32 nozzle
34 segment-heap of . . .
36 cubes of foam plastic media material
38 collecting basin
40 outlet-port
41 inner wall of segment
42 outer wall
52 hollow interior segment-cavity
54 lifting eyelets
56 lid
60 (FIG. 3) intermediate segment
61 inner wall of segment
63 outer wall
65 upper flange
67 top retainer
69 crossbars
70 bottom flange
74 (FIG. 5) double wall ring
76 top segment
78 bottom segment
80 intermediate segment
81 top segment closure
83 gasket seals

1. Wastewater treatment apparatus, wherein:
the apparatus is able to treat sewage wastewater;
the apparatus includes media material, which is of such nature as to permit establishment therein of colonies of bacteria capable of breaking down contaminants in the wastewater;
the apparatus includes a number of segments;
each segment is a coordinated structure, of such robust integrity that the segment can be picked up, and can be transported to the site, as a stand-alone self-contained unit;
the segments are assemblable together at the site;
the segments are so structured that the segments can be placed one on top of another, and can thereby be assembled into a tower or stack of segments;
each segment includes structure that is effective, the segments having been assembled into the tower, to prevent relative lateral movement between that segment and adjacent segments in the tower;
the segments have respective segment-walls, which form respective encirclements;
the tower of segments includes a top segment, a bottom segment, and at least one intermediate segment;
the intermediate segment is open, top and bottom, to the throughflow of water and air in the up/down direction through the segment;
the intermediate segment is provided with a retainer, which, in conjunction with the segment-wall of that segment, defines and encloses a hollow interior segment-cavity of the segment;
a segment-heap of pieces of the media material lie contained, by the wall and by the retainer, within the segment-cavity;
the retainer is of such open structure as to allow passage of water and of air therethrough, and into and through the segment-cavity of that segment;
the retainer is of such closed structure, with respect to the size and shape of the pieces of media material, as to prevent movement of the pieces through the retainer;
the segment-heap is permeable to the through-flow of wastewater and is so arranged that air can pass, in the up/down direction, through the segment-heap;
the configuration of the assembled tower is such that the segments, together, contain and define a hollow interior vault of the tower;
the segment-cavity is inside, and is a component of, the vault;
the structure of the assembled tower is such that, upon wastewater being introduced into the top segment of the tower, the wastewater descends down through the segments, segment by segment, through the pieces of media material of the segment-heap contained in the segment-cavity, and down into the bottom segment, from which the now-treated water drains out of the apparatus.

2. As in claim 1, wherein the media material has a substantial ability to retain water by capillary action.

3. As in claim 2, wherein:
the media material is substantially inert with respect to water and to contaminants contained in the wastewater;
the pieces of media material are respective separate cubes of soft resilient interconnected-cell foam.

4. As in claim 1, wherein the pieces that form the segment-heap are randomly heaped in such manner as to permit air to pass in the up/down direction through the segment-heap, between the pieces.

5. As in claim 1, wherein:
the top segment has an inlet port for receiving wastewater;
the top segment has a conduit for conveying wastewater received through the inlet port to a nozzle, for even distribution over the media material below.

6. As in claim 1, wherein the bottom segment includes a collecting basin, and includes an outlet port for conveying now-treated water out of the apparatus.

7. As in claim 1, wherein the segments are of such structure and configuration that the task of assembling the segments at the site, to form the tower, comprises simply placing the segments one on top of another.

8. As in claim 1, wherein the segments are so structured and configured in relation to each other that the vault inside the assembled tower or stack of segments is made substantially watertight, simply upon the segments being assembled on top of each other, without need for assembly of seals or fasteners at the site where the tower is assembled.

9. As in claim 1, wherein the apparatus is of such structure and configuration that, the tower having been assembled, the apparatus can be made operational simply upon connecting a supply of wastewater to the inlet port.

10. As in claim 1, wherein the apparatus includes an operable dosing structure, which is effective, when operated, to deliver wastewater to the inlet-port of the top segment, by intermittent dosing.

11. As in claim 1, wherein the segment-wall comprises an inner-wall and an outer-wall, with an annular airspace therebetween, and the segment-cavity is defined by the inner-wall.

12. As in claim 11, wherein:
the outer wall is moulded upon an annular segment-wall-mould, which is profiled in the form of the annular airspace;
the profile of the mould includes a draft angle, so arranged that the moulded width of the airspace at the distal end of the profile is smaller than the moulded width of the space at the proximal end;
the distal end and the proximal end of the segment-wall are provided with complementary nestling configurations;
the difference between the two moulded-widths is such that, when the segments are assembled on top of one another to form the tower, the distal end of one segment and the proximal-end of the next-above segment nestle snugly and securely together, but with clearance.

13. As in claim 1, wherein:
the retainer comprises a top-retainer and an open-mesh bottom-retainer;
the top-retainer is secured to the wall of the cavity, and closes the open top of the segment-cavity;
the bottom-retainer is secured to the wall of the cavity, and closes the open bottom of the segment-cavity;
the top-retainer and the bottom-retainer are of open mesh construction;
whereby air and water passage through the retainers is substantially uninhibited by the retainers.

14. As in claim 13, wherein the top-retainer and the bottom-retainer of the intermediate segment are detachably fastenable to the wall of the segment in such manner as to hold and contain the pieces of media material within the segment-cavity and between the top-retainer and the bottom-retainer.

15. As in claim 1, wherein the segments are right-cylindrical, and are of such size and structure that the segments, each on its own, can be rolled over the ground for short-distance transportation.

16. As in claim 15, wherein the structure of the intermediate segment is such that, the two retainers being in the closed condition, and the segment is being rolled over the ground, the pieces of media material are inescapably constrained by the top-retainer and the bottom-retainer, within the segment-cavity.

17. As in claim 1, wherein the vault is vented to the outside air.
